(19) United States
(12) Patent Application Publication
(10) Pub. No.: US 2002/0068123 A1
(43) Pub. Date: Jun. 6, 2002

(54) Method of inducing sweetness by gallic acid and its applications

(76) Inventors: Justis Verhagen, Oxford (GB); Thomas R. Scott, La Mesa, CA (US); Barbara K. Giza, Chadds Ford, PA (US)

Correspondence Address: Connolly Bove Lodge & Hutz LLP, 1220 Market Street, P.O. Box 2207, Wilmington, DE, 19899, US

(21) Appl. No.: 09/875,238

(22) Filed: Jun. 6, 2001

Related U.S. Application Data
(60) Provisional application No. 60/209,556, filed on Jun. 6, 2000.

(51) Int. Cl. A23L 1/236

(52) U.S. Cl. 426/548

(57) ABSTRACT

Gallic acid is a useful sweetener for foods, beverages and medicaments.

This application claims priority from Provisional Application No. 60/209,556 filed Jun. 6, 2000.

The invention concerns a novel use of the compound gallic acid (1,2,3-trihydroxybenzoic acid) as sweetness inducer per se and the applications made possible thereby. This is also meant to include related compounds such as trihydroxybenzenes and dihydroxybenzenes in general, as well as their acids, esters and other derivatives.

The compound gallic acid is well known and well studied. It is found in tea, wine grapes, nutgall and other plants and the beverages prepared from them. It has known uses such as in tanning, as photographic developer, and as an astringent in veterinary science.

It was found that a green tea extract was able to block neural taste responses to sugars in rats. Subsequent human trials showed that this extract suppressed both sweetness and saltiness. In researching which of the ingredients of this extract caused inhibition, the components (+)-catechin, (−)-epicatechin and gallic acid were investigated. None was effective in suppressing sweet taste perceptions. However, it was noted that the gallic acid induced a distinct and long-lasting sweet aftertaste, and to have only a mildly sour initial taste. Overall, the taste experience is a pleasant one.

Phloroglucinol (1,3,5 trihydroxybenzene), a related compound, is reported in the Merck Index (ninth edition, Merck & Co. 1976) to have sweet taste. Hence, our invention disclosure extends the finding of gallic acid's sweetness inducing effects to that of any trihydroxybenzene.

It has been known that for substances to taste sweet they need to satisfy various structural rules. One of those is that such a substance should be able to form 2 hydrogen bonds. Therefore, dihydroxybenzenes as well as trihydroxybenzenes should have sweetness inducing effects.

Any of the derivatives of the dihydroxybenzenes or trihydroxybenzenes are also meant to be included in this invention. These can still allow for the sweetness to be induced (and possibly induce an even stronger tasting sweetness) but at the same time minimize any non-sweet taste (e.g. initial sourness in case of gallic acid). Thus, purer and/or stronger tasting sweetness inducers can be obtained from the above mentioned chemical groups.

Modifiers of sweet taste can be divided into 3 groups; taste inhibitors, inducers and transinducers. Sweetness inhibitors include ziziphins, gurmarin and gymnemic acids. The only known transinducer is miraculin (which makes a sour substance taste sweet.) Sweetness inducers differ from the “sweeteners” in that they can cause a sweet taste after they have been rinsed out of the mouth. Usually this results in a perceived sweetness if the mouth is subsequently exposed to water or other substances (e.g. milk, wine or saliva). Furthermore, sweetness adaptation occurs after sweeteners whereas not to sweetness inducers. Inducers of sweet taste comprise strogins, curculin, chlorogenic acid, cynarin, and catechins.

Gallic acid has distinct advantages over other sweet inducers. Its effect seems more powerful and enduring. Moreover, the initial taste of gallic acid itself is 0.05 M is only mildly sour, in contrast to the unpleasant bitter taste of catechins. Finally, gallic acid is readily available (e.g. Aldrich Chemicals) at a reasonable cost ($60/kg). Other sweet inducers are either unavailable commercially curculin, strogins, cynarin and miraculin) or are 50 (catechins) to 500 (chlorogenic acid) times as expensive.

The advantage of gallic acid over sweeteners is that the induced sweetness is non-caloric, long-lasting and does not have any non-sweet aftertaste (e.g. aspartame has a metallic aftertaste).

Gallic acid is regarded as a non-toxic substance to man. Furthermore, considerable health-promoting effects have been ascribed to gallic acid. It is characterized as antimicrobial, antioxidative, anticarcinogenic, hypotensive, serum lipid reducing, antiatherogenic, anticariogenic and heavy metal chelating.

This combination of sweetness induction, low cost, ready availability and health promotion make gallic acid a compound with unique advantages.

Examples of use could use of the sweeteners as a multifunctional ingredient in toothpaste. Gallic acid has known anticaries effects. As a sweetness inducer, it could counter the sweet-suppressive effects of the surfactant lauryl sulfate (whose effects are responsible for making orange juice taste sour after brushing). The long lasting sweetness will allow for prolonged salivation which has been found to have a positive effect on oral pH and hygiene. For the same reasons it could be incorporated into a mouthwash.

Another use could be in chewing gum. Here a long-lasting sweetness is wanted without either a caloric ballast, or cariogenic properties. Gallic acid could be included in crystalline form in the gum, only to become active upon dissolving in the saliva, allowing for long shelf-life. The health promoting effects of gallic acid could be ascribed to the gum as well as for marketing purpose.

More generally, it could be used as a sweet-inducing agent in beverages (especially acidic juices) and foods to prolong sweet taste (baking products, syrups, candy, etc.).

The invention has been evaluated experimentally with human subjects, and magnitude estimations have been made of the sweetness of gallic acid, which confirm its usefulness as a sweetener.

The U.S. Pat. No. 4,906,480, which describes chemically related compounds (catechins and flavanols) to be used as sweeteners or sweetness enhancers, is of interest as background. Schiffman et al. Brain Research, 595: pp. 1-11 (1992) teaches that astringent compounds suppress taste responses in gerbils.

We claim:

1. A sweetener comprising gallic acid.

2. A food, beverage or medicament sweetened with gallic acid.

3. A method of sweetening a food, beverage or medicament comprising adding gallic acid.
